(19) United States
(12) Patent Application Publication
(10) Pub. No.: US 2017/0255189 A1
(43) Pub. Date: Sep. 7, 2017

(54) CONFIGURABLE MONITORING SYSTEM AND METHOD

(71) Applicant: CHARGEPOINT TECHNOLOGY LIMITED, Liverpool (GB)

(72) Inventors: Richard Athol Barton, Salford (GB); Adam Guy Bunyard, East Sussex (GB)

(21) Appl. No.: 15/501,062

(22) PCT Filed: Jul. 30, 2015
(86) PCT No.: PCT/GB2015/052206

§ 371 Date: Feb. 1, 2017

(30) Foreign Application Priority Data
Aug. 1, 2014 (GB) 1413713.7

(51) Int. Cl. G05B 23/02; G05B 19/042

(52) U.S. Cl. CPC G05B 23/0208; G05B 19/0426; G05B 2219/25428; G05B 2219/34444

(57) ABSTRACT

A system for remotely monitoring a process or equipment comprises: processing means for receiving one or more sensed outputs representative of one or more environmental conditions and/or process parameters and/or equipment conditions; interface means configurable by a user for selecting a subset of the one or more sensed outputs and for defining at least one output data string dependent on the one or more sensed outputs; and communication means for transmitting the at least one output data string.

This invention relates to a configurable monitoring system and method. In particular, this invention relates to a user configurable system and method for remotely monitoring a process or product. The configurable system and method for remotely monitoring a process or product can be configured locally or remotely using an application software.

Various types of remote monitoring sensors are available in the marketplace which have a preconfigured monitoring function. However, this functionality is often limited by the number and type of sensors hardwired onto the device and its hardwired processing and logic capabilities, and, as such, offers few possibilities to customise the monitoring function of the device, and no chance to add functionality without additional accessory devices or sensors being connected thereto.

To overcome these limitations in the prior art, it is an object of the present invention to provide a remote monitoring system and method having user configurable functionality. The functionality of the device is configured using a graphical user interface or application software. These device settings are synchronised or downloaded to the monitoring device via a wireless network. In this way, different users can customise the behaviour of the remote monitoring device and can tailor its functionality, without the intervention of the manufacturer. The present invention provides for much increased functionality and flexibility of the remote monitoring device, with no additional accessory or hardware costs.

According to the present invention there is provided a system for remotely monitoring a process or equipment, comprising:
processing means for receiving one or more sensed outputs representative of one or more environmental conditions and/or process parameters and/or equipment conditions;
interface means configurable by a user for selecting a subset of the one or more sensed outputs and for defining at least one output data string dependent on the one or more sensed outputs; and
communication means for transmitting the at least one output data string.

Preferably, the process is a process used in the manufacture of pharmaceutical products and/or the equipment is pharmaceutical process equipment.

Further preferably, the pharmaceutical process equipment comprises at least one valve or coupling.

In use, the pharmaceutical process equipment may comprise an extraction and/or filtration system.

Preferably, the pharmaceutical process equipment comprises a glove box containment apparatus.

Further preferably, the at least one valve or coupling is a powder transfer valve or coupling.

In use, the valve or coupling may be selected from the group consisting of split butterfly valve, split sliding gate valve, split ball valve, twin valve, rapid transfer port and alpha beta port.

Preferably, the processing means is positioned on an actuator.

Further preferably, the actuator comprises a manually-operable handle having an elongate shaft; one end of the shaft being rounded or dimensioned to form a knob; the other end of the shaft being dimensioned to form a central hub.

In use, the central hub may comprise a first face for connection to the valve or coupling and an opposite second face that is visible to the operator.

Preferably, the first face of the central hub comprises a socket dimensioned to connect with a square spigot on the valve or coupling.

Further preferably, the central hub defines a generally circular body into which a printed circuit board, battery and liquid crystal display is contained.

In use, the central hub may define a sealed, ingress protected enclosure.

Preferably, the processing means and communciation means are located on the printed circuit board.

Further preferably, the processing means is implemented in a low power microcontroller.

In use, the processing means may receive a wake-up signal from user input buttons and/or from the one or more sensed outputs representative of one or more environmental conditions and/or process parameters and/or equipment conditions embedded on, or remote to, the printed circuit board.

Preferably, the system may comprise display means for displaying at least one output signal to an operator via audio-visual, alphanumeric and/or haptic information.

Further preferably, the one or more sensed outputs representative of one or more environmental conditions and/or process parameters and/or equipment conditions is selected from the group consisting of ambient temperature, process temperature, flow rate, light intensity, humidity, atmospheric pressure, process or material pressure, force measurement, operation time, power usage.

In use, the one or more sensed outputs may be selected from the group consisting of photodiode, photoresistor, photodetector, resistance temperature detector, thermocouple, thermistor, piezoelectric, potentiometer, strain gauge, air flow sensor, anemometer, microphone, proximity sensor, motion sensor, Hall effect sensor.

Preferably, the at least one output data string dependent on the one or more sensed outputs is an error, misuse, or fault condition.

Further preferably, the error, misuse, or fault condition is transmitted back to a remote server using a wired or wireless communications means.

In use, the processing means may include a GPS location module which records the location of the process or equipment.

Preferably, the processing means includes a unique identifier.

Also according to the present invention there is provided a system to monitor a process or equipment, comprising:
a central server;
a remote sensing device including a microprocessor for receiving one or more sensed outputs representative of one or more environmental conditions and/or process parameters and/or equipment conditions;
interface means in communication with the central server and the remote sensing device, the interface means being configurable by a user for selecting a subset of the one or more sensed outputs and for defining at least one output data string dependent on the one or more sensed outputs; and
wherein the central server is operable to download the user configurable data and at least one output data string over a wireless network.

Further according to the present invention there is provided a method of remotely monitoring a sensing device connected to a network, the sensing device comprising a microprocessor for receiving one or more sensed outputs representative of one or more environmental conditions and/or process parameters and/or equipment conditions, the method comprising the steps of:
selecting a subset of the one or more sensed outputs;
defining at least one configurable output data string dependent on the one or more sensed outputs; and
downloading the at least one configurable output data string to the sensing device.

Preferably, the method further comprises the steps of:
assigning a unique user identifier;
assigning a unique device identifier; and
associating the unique user identifier with the unique device identifier.

Further preferably, the method further comprises the step of:
providing location information for the sensing device.

In use, the method may further comprise the step of:
providing location information and/or a unique identifier for the process or equipment.

Preferably, the method further comprises the step of:
setting visual and/or audible display options for the sensing device.

Further preferably, the step of selecting a subset of the one or more sensed outputs further comprises disabling one or more sensed outputs representative of one or more environmental conditions and/or process parameters and/or equipment conditions.

In use, the step of defining at least one configurable output data string further may comprise defining at least one error, misuse, fault and/or event condition based on the subset of sensed outputs.

Preferably, the step of transmitting the at least one configurable output data string populated by the at least one error, misuse, fault and/or event condition over a network.

Further preferably, the selecting and defining steps of the method are carried out using a graphical user interface and/or application software.

Also further according to the present invention there is provided a computer program product for remotely monitoring a sensing device connected to a network, the sensing device comprising a microprocessor for receiving one or more sensed outputs representative of one or more environmental conditions and/or process parameters and/or equipment conditions, comprising:
computer program product means for selecting a subset of the one or more sensed outputs;
computer program product means for defining at least one configurable output data string dependent on the one or more sensed outputs; and
computer program product means for downloading the at least one configurable output data string to the sensing device.

It is believed that a system and apparatus in accordance with the present invention at least addresses the problems outlined above. The advantages of the present invention are that a remote monitoring device can be placed on or in the vicinity of a product or process which enables the sensing of one or more environmental conditions and/or process parameters and/or equipment conditions. Advantageously, the present invention provides a remote monitoring device and method having user configurable functionality. Different users can customise the behaviour of the remote monitoring device and can tailor its functionality, without the intervention of the manufacturer. The present invention advantageously provides for much increased functionality and flexibility of the remote monitoring device, with no additional accessory or hardware costs. Further advantageously, the software that is running on the remote monitoring device can be significantly changed or configured remotely via the graphical user interface or application software running on an internet connected server. The user is able to make significant changes to the look and functionality of the remote monitoring device and its user interface; turning on and off sensors, and altering the types of data that is recorded and the data that is transmitted to the server. Further advantageously, the application software for customising the behaviour of the remote monitoring device provides a user friendly and intuitive interface.

It will be obvious to those skilled in the art that variations of the present invention are possible and it is intended that the present invention may be used other than as specifically described herein.

Specific non-limiting embodiments of the invention will now be described by way of example only and with reference to the accompanying drawings, in which:

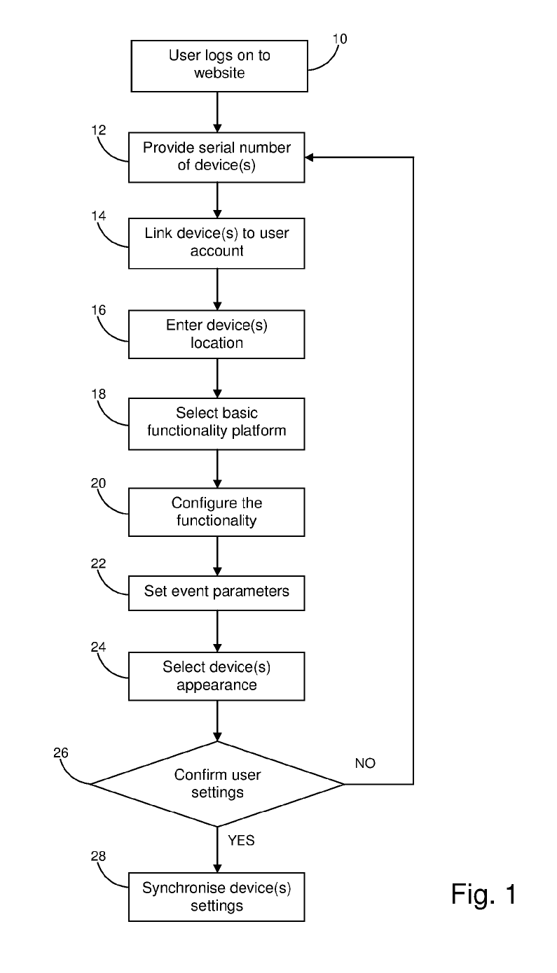

FIG. 1 illustrates a flow diagram showing how the remote monitoring device of the present invention is configured;

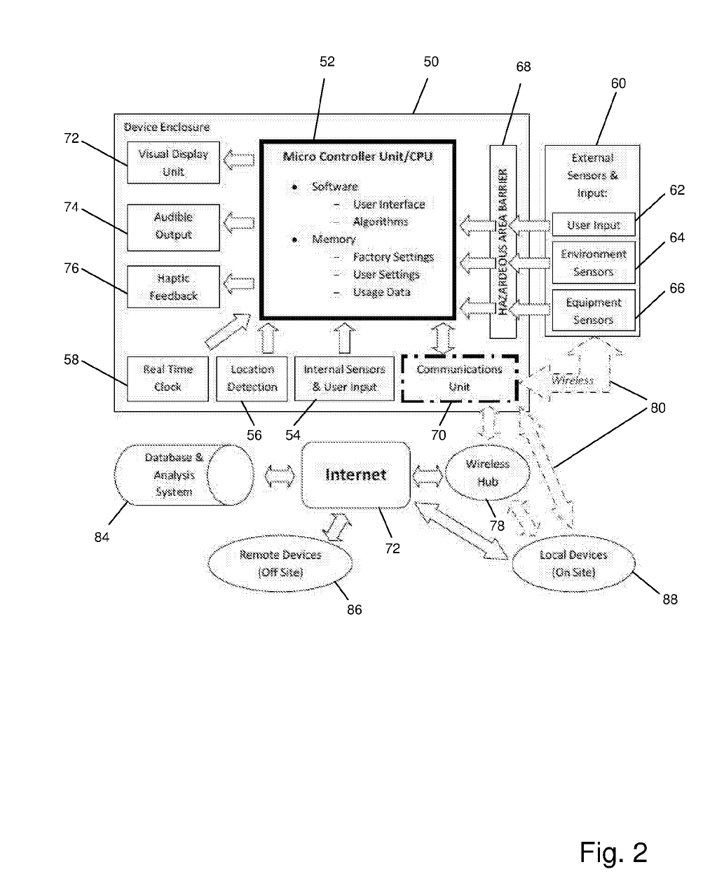

FIG. 2 is a high-level schematic diagram showing how the present invention is implemented;

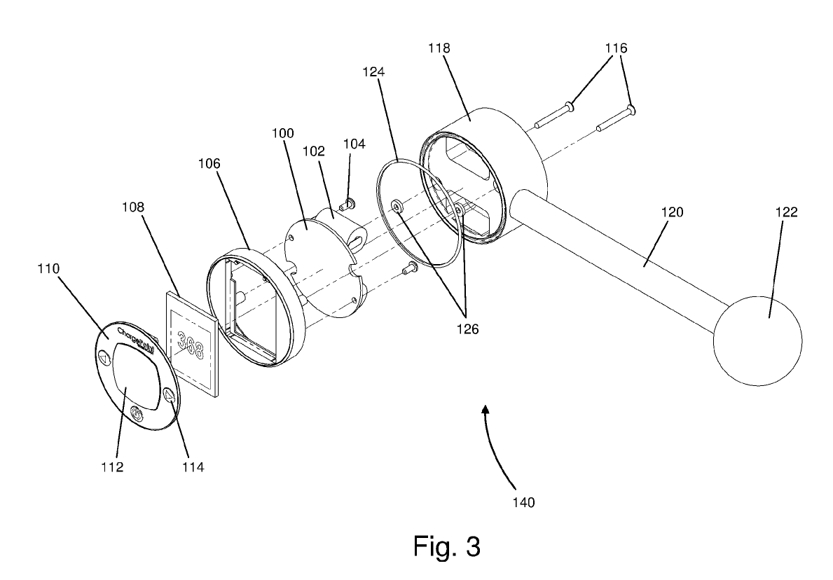

FIG. 3 shows how the remote monitoring device of the present application can be embodied in a valve-actuating handle for manual operation of a split valve assembly; and

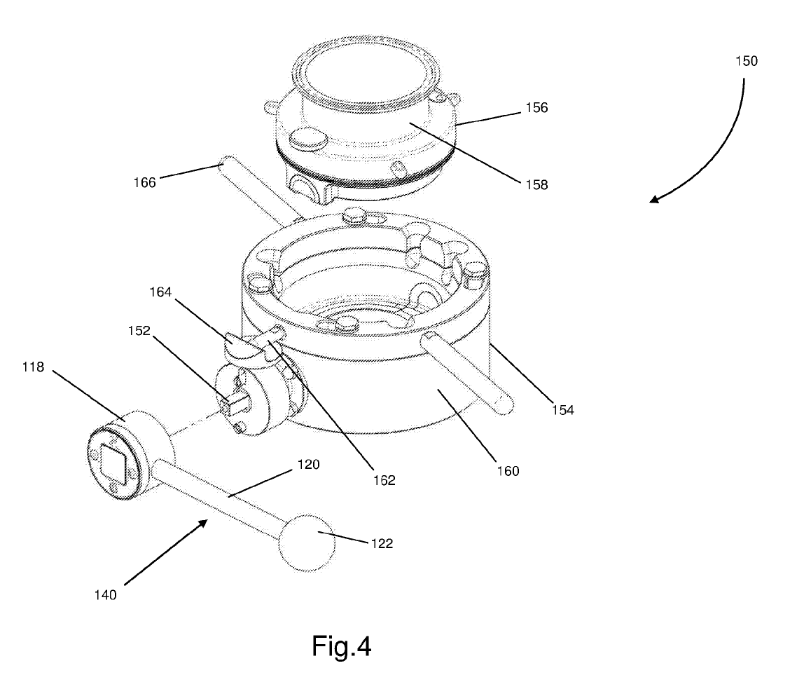

FIG. 4 shows how the valve-actuating handle containing the remote monitoring device can be connected to a split valve assembly for manual operation.

Referring now to the drawings, the system and method according to the present invention has been developed for incorporation into any type or form of remote monitoring device. Such a remote monitoring device can be utilised for sensing one or more environmental conditions and/or process parameters and/or equipment conditions in the vicinity of the remote monitoring device.

To allow for user configurable device settings to be written in a graphical user interface or application software and then synchronising the device settings to the monitoring device via a wireless network, the present invention makes use of a remote customisation method. Further detail on each aspect of the method is described in relation to FIG. 1. In the following description each step of the accompanying drawings will be referred to as “S” followed by the step number, e.g. S10, S12 etc.

Whilst the present invention has been developed specifically for the remote monitoring of one or more environmental conditions and/or process parameters and/or equipment conditions on, or in the vicinity of, valve assemblies for controlling, charging, discharging and/or regulating the flow of powders, liquids, slurries, tablets and/or fluid, this is in no way intended to be limiting as, in use, the remote monitoring device can be utilised in many different types of industries and applications.

Remote monitoring of one or more environmental conditions or and/or process parameters and/or equipment conditions can include, but is not limited to, monitoring of ambient temperature, process temperature, flow rate, light intensity, humidity, process level, atmospheric pressure, density, process pressure, pH measurement, force measurement, fluid velocity, satellite position, position, angle, displacement, distance, speed, acceleration, sound, vibration, frequency, proximity, ionising radiation, electric current, electric potential, signal measurement, operation time, power usage. In addition, the skilled person will appreciate that environmental conditions are often inextricably linked with process parameters. For example, environmental conditions, such as relative humidity, can significantly affect the behaviour of various powders, dust, granular and semi-solid ingredients. Equally, equipment conditions, such as excessive wear on the viscoelastic valve components and seats, can significantly affect the process parameters and/or may be used to predict critical valve failure.

The method of remotely customising the remote monitoring device, via a website, is illustrated in FIG. 1. After the device has been configured or customised locally or remotely using the graphical user interface or application software, it can be placed on or in the vicinity of a product or process which enables the sensing of one or more environmental conditions and/or process parameters and/or equipment conditions.

At S10, the user would firstly log on to a website. The website is effectively a portal that will allow all interactions (inputs/outputs) with the remote monitoring device.

At S12, the user enters the unique identifier of the remote monitoring device that is being configured. The unique identifier of the remote monitoring device then brings up basic information about the device, which would have already been pre-loaded to the website at the manufacturing stage. Alternatively, the basic information about the device is stored on the device, and that can be accessed via a web address linked to the device. The basic information about the device can include, but is not limited to, basic hardware and software configuration, battery type and capacity, information on the number and type of internal and external environment and equipment sensors, initial input and display settings etc.

Once the device has been identified, at S14, it would be linked to the account of the user, and further information about the identity and location of the remote monitoring device could be entered at S16. For example, the room number or building name could be entered, or the process equipment to which the device is fitted to could be listed. The further information, at S16, can also include the unique identifier of the machine or process to which the remote monitoring device is fitted or associated with.

At S18, the user can select, via the website, the basic functionality platform for the device (or multiple devices) from a range of options. An example could be a “filter monitoring” platform, or “movement detection” platform or “electric motor monitoring” platform etc.

Each basic functionality platform has a set of default software elements which makes the device suitable for monitoring a different set of environmental conditions and/or process parameters and/or user inputs.

As the device has a range of sensors which may or may not be suitable for each application, by choosing the platform the user is selecting which sensors they would like to use, and in which way, for their particular application.

For example, the “filter monitoring” platform could enable the pressure sensors contained in the device and disable the accelerometer sensors, and the software would then display information to the user that was suitable for measuring a pressure differential across a filter element.

The platform would also provide a number of default “events” for the user to choose from. An “event” is when a change in the sensed data from the sensors is deemed important enough to be recorded. The change in data is given a name and the time and date when it occurs is recorded. An example would be an event called “rotation” which is when an accelerometer detects rotation about a certain threshold and the exact time and date of the occurrence of the rotation is recorded.

The skilled person will appreciate that the number of basic functionality platforms available can be added to in time as more platforms are released for use.

The next step, at S20, is for the user to configure the functionality of the remote monitoring device. The user could choose which “events” they would like to select from those initially offered in the basic functionality platform default list available, or alternatively select other “events” that were not initially offered. The user could also select what screens and options that the end user of the remote monitoring device would see in the device's local display, again selected from a range of default options, and define any error, misuse, or fault operations or conditions.

The following step, at S22, would be to set the event parameters on the remote monitoring device. An “event” might be a sensed condition or input stimuli that would cause caution or alarm (for example a maximum temperature being exceeded), or when a combination of readings (e.g. a pressure differential across a filter element) would be considered to be an event that should be otherwise recorded.

Other additional parameters would also be set at this stage might include setting the time interval between remote synchronisations of the device with the website server, and other time-based functionality.

At S24, the user would then select a visual and audible style for the remote monitoring device from a range of options. This would be tested via an emulator on the website that would enable the user to experience the look of the display screen on the remote monitoring device and the reaction of the device to different input stimuli.

The user would further personalise the remote monitoring device by inserting additional text, altering the font, background colours and inserting desired icons, logos or images.

At S26, the user is then prompted to save the completed software file on the website, ready to be installed on a single remote monitoring device, or multiple devices, depending on what was selected at S12. The user can synchronise the software on the device by either waiting until the next default data transfer is scheduled to take place, or they can prompt or “force” a transfer by manually selecting the option on the device.

FIG. 2 is a schematic diagram showing how the user configurable system and method for remotely monitoring a process or product can be implemented in a small, self-powered unit 50 that includes a low power microcontroller 52. As shown in FIG. 2, the microcontroller 52 receives a number of inputs generally indicated at the lowermost and right hand side of element 50.

The microcontroller 52 can be considered a self-contained system with a processor, memory and peripherals and can be used to display local information to the end user via a number of outputs generally indicated in the left hand side of element 50.

FIG. 2 is a schematic diagram and, in order to aid clarification, many other circuit elements are not shown. For example, although not shown in FIG. 2, the analogue signal received from one or more sensors 54 embedded on the printed circuit board, or external sensors 64 remote to the microcontroller 52, is first converted to a digital form by any suitable type of analogue-to-digital convertor (ADC) available in the art. Equally, one or more of the digital outputs of the microcontroller 52 can be converted to analogue form using any form of digital-to-analogue convertor (DAC) available in the art. For example, such an analogue output signal could be used to energise an audible output 74.

In operation, a set of instructions or algorithm written in software in the microcontroller 52 are configured to program the microcontroller 52. In use, the microcontroller 52, including the processor, memory and peripherals, can be firstly placed in a low power, standby mode, awaiting a wake-up signal. The wake-up signal can be received from the user input buttons and/or from one or more environmental sensors 54 embedded on the printed circuit board and/or from one or more equipment sensors 66, environmental sensors 64 and/or user inputs 62 and/or process sensors (not shown in FIG. 2) remote to the microcontroller 52. In its most basic mode of operation, the microcontroller 52 can be effectively woken-up from standby mode by the operator pressing the on/off or standby button 54 located on the device 50.

In addition or alternatively, the microcontroller 52 could effectively be woken-up from low power standby mode by any number of input stimuli. In one embodiment, one of the equipment sensors 66 is a positional sensor which senses the rotational position of an operator handle relative to a valve assembly. In use, the positional sensor is a three-axis accelerometer, and which is receptive to small input stimuli including rotation, pulse, shock, impact and/or vibration to firstly awaken the microcontroller 52. The skilled person will appreciate that the positional sensor could also be implemented using other multi-axis accelerometers, such as a six-axis accelerometer, or by the use of rotational optical encoders or on/off sensors and switches.

The one or more equipment sensors 66, environmental sensors 64 and/or user inputs 62 and/or process sensors (not shown in FIG. 2) remote to the microcontroller 52 information can be inputted to the microcontroller 52 via a suitable wired or wireless communication protocol 80, including for example, Bluetooth, ZigBee, or over a cellular network.

When the microcontroller 52 has been woken-up, it then senses the output of the three-axis accelerometer to determine the orientation and position of the rotation of the valve-actuating handle. If the output of the three-axis accelerometer corresponds to one or more of the predetermined events that have been configured on initialling customising the device 50, the event would be considered to be an event that should be otherwise recorded. In this example, the event written in software could be called “rotation” which is when an accelerometer detects rotation about a certain threshold and the exact time and date of the occurrence of the rotation is recorded.

In a preferred embodiment, only the information relevant to each individual event are recorded to preserve battery life and reduce local storage requirements. The device can also be configured to sample and record in memory all of the outputs of the one or more environmental sensors 54 embedded on the printed circuit board and/or from one or more equipment sensors 66, environmental sensors 64 and/or user inputs 62 and/or process sensors (not shown in FIG. 2) remote to the microcontroller 52. Sampling of all of the sensors in this way provides a snapshot in time and which gives a large deal of information surrounding each event which can useful for batch or process traceability and/or failure analysis.

The skilled person can also appreciate that the device can be configured simply as a data logger, reading and recording the output of the one or more of the sensors with a fixed or variable sampling rate.

The display unit 72 on the remote monitoring device 50 can be used to display the obtained sensed data to the end user, as configured at S24, and/or can include one or any combination of output signals to the display unit 72, such as an audible output or alarm 74 or some form of haptic feedback 76.

For the example, the display 72 could be used to display the number of times the valve has been opened or closed, and also display additional information such as the service life data, or the output of any of the environmental sensors 64 which record conditions such as external/internal temperature, light intensity, humidity, atmospheric pressure, force measurement and operation time. The one or more sensors 54 embedded on the printed circuit board and/or the one or more environmental sensors 64 positioned remotely to the microcontroller 52 can be selected from the group consisting of photodiode, photoresistor, photodetector, resistance temperature detector, thermocouple, thermistor, piezoelectric, potentiometer, strain gauge, air flow sensor, anemometer, microphone, proximity sensor, motion sensor, Hall effect sensor.

If the output of the sensors 54, 64 corresponds to one or more of the predetermined events that have been configured on initialling customising the device 50, that event would be recorded. The event could be an overtemperature or other process or environmental condition, as configured on initialling customising the device 50. As explained, an example would be an event called “rotation” which is when an accelerometer detects rotation about a certain threshold and the exact time and date of the occurrence of the rotation is recorded in memory.

In addition to recording specific events, the microcontroller 52 could also record the total time that the valve has been in use, and the temperature that the valve has been exposed to, as configured by the user on initialling customising the device 50. These may be received from one or more environmental sensors 54 embedded on the printed circuit board and/or one or more environmental sensors 64 positioned remotely to, but in the vicinity of, the valve. The interaction of the operator with the device, via input buttons 54 (or via any other input/output means) can also be monitored and stored.

As well as the microcontroller 52 outputting the sensed one or more environmental conditions or process parameters in the vicinity of the sensing device, it is envisaged that this information can be stored in local memory for further local or remote analysis. This information can be accessed locally and/or transmitted back to a central database 84 connected via the internet 72 using a communications unit 70 which may be a suitable wired or wireless communication protocol 78, including for example, Bluetooth, ZigBee, or over a cellular network.

Captured information can be transmitted from the microcontroller 52 to central database 84 or dedicated web server or web-enabled device which is local 88 (i.e. on-site) or remote 86 (i.e. off-site).

Whilst data transmission can occur via a wired network, in a preferred embodiment, data transmission is over a wireless network which has advantages in terms of lower cost and quicker installation. The data is then available to a user online via the local 88 or remote devices 86. In this way, one or more appropriately authorised users can access the captured information obtained from the remote monitoring device 50.

The skilled person can also envisage that the present invention can be provided in a number of self-contained monitoring units 50 monitoring a number of valves or sensing of one or more other environmental conditions or process parameters at locations situated throughout a production line or facility. Each communications unit 70 of the device 50 can then be configured as a node of a wireless mesh network system which provides a very robust network, as each node only needs only transmit as far as the next node. Nodes act as routers to transmit data from nearby nodes to peers that are too far away to reach in a single hop, resulting in a network that can cover larger distances.

It is desirable that the wireless network has low power consumption, enabling several years of operation between battery changes.

As an alternative to the wireless network described hereinbefore, transmission of the data may occur over a WiFi network.

It is also envisaged that the microcontroller 52 could also include or has embedded therein a GPS location module 56 which records the actual location of the device 50. If configured by the user, these parameters could be stored in local memory and transmitted back to a central database 84, via the communications unit 70, when the next preconfigured data transfer is scheduled to take place.

The device is battery-powered and sealed to the environment (i.e. ingress protected) and safe for used in hazardous and/or potentially explosive environments (e.g. ATEX rated). The microcontroller 52 utilises low power components so that the system is designed to provide a long battery life.

FIGS. 3 and 4 show how the remote monitoring device 50 of the present application can be embodied in a valve-actuating handle 140 for manual operation of a split valve assembly 150.

As shown in FIG. 3, the valve-actuating handle 140 is formed having a solid handle shaft or arm 120; one end of which forms a knob 122 or is rounded. The other end of the handle shaft or arm 120 is secured to a hub 118 which is formed as a unitary, machined part. The rear face of the hub 118, i.e. the face that is placed in contact with the split valve assembly 150, defines a socket (not shown) which is dimensioned to connect with a square spigot 152 on the split valve assembly 150, as best illustrated in FIG. 4.

The front face of the hub 118, i.e. the face that is visible to the operator, is generally circular in shape.

As best shown in FIG. 3, the hub 118 includes a generally annular housing 106 into which a printed circuit board (PCB) 100 and power source or battery 102 is secured via fixing screws 104. A colour liquid crystal display (LCD) 108 is positioned inside the aperture in the housing 106, opposite the PCB 100. The colour LCD display 108 is then secured in a screen sub-assembly 110 which includes a protective, transparent screen or window 112 at its centre and operation or function buttons 114 positioned around the radius of the screen sub-assembly 110 for ease of access. The buttons 114 include a power on/off button, standby and/or one or more function buttons.

As the valve-actuating handle 140 is intended to be used in environmentally-challenging conditions, including containing, regulating and controlling hazardous powders, dust, granular and semi-solid ingredients, the housing 106 and screen sub-assembly 110 are secured together using assembly screws 116 and internal O-ring seals 126 which secure the housing 106 and screen sub-assembly 110 to the hub 118 against a circumferential seal 124.

To provide functionality, the PCB 100 includes various hardware, software, sensors and components, as described in detail in relation to FIG. 2.

FIGS. 3 and 4 show how the present invention can be embodied in a valve-actuating handle 140 for manual operation of a valve or coupling, and particularly a split valve assembly 150 for containing, regulating and controlling hazardous powders, dust, granular and semi-solid ingredients. In use, operator rotation of the valve-actuating handle 140 controls respective pivotally-mounted valve closure members (not shown) inside the split valve assembly 150.

In an alternative embodiment, the hub 118 would be secured to the split valve assembly 150, with the valve-actuating handle 140 being rotatable within the body of the hub 118 to rotate the socket. In this manner, the LCD display 108, and the operation and/or function buttons 114 positioned around the radius of the screen sub-assembly 110, are positioned in a fixed orientation for the user.

As shown in FIG. 4, the split valve assembly 150 comprises two valve portions, an upper, passive valve portion 156 and a lower, active valve portion 154. The passive valve portion 156 defines a valve housing 158 which is generally annular in shape. The active valve portion 154 defines a valve housing 160 which is also generally annular in shape. The two valve portions 154, 156 are complementarily shaped such that one can sealingly engage and co-operate with the other to allow the movement of material therethrough. Although not shown in FIG. 4, each valve potion includes valve closure members which are pivotally-mounted within the housings 158, 160. Each valve closure member is in the form of an annular disc, and each is provided with spindles by means of which each valve closure member is pivotally rotatable.

Although not shown in FIG. 4, the spindle of the lower, active valve portion 154 is connected to, or is integrally formed with, spigot 152. Thus, rotation of the spindle is moved by rotation of the spigot 152. The spindle of the upper, passive valve portion 156 is connected to spigot 152. A mechanical safety interlock ensures the safe operation of the split valve assembly 150. When the two valve portions are correctly docked, the mechanical interlock pin 162 on the active valve portion 154 releases the profiled release pin 164 on the active valve portion 154 which allows the valve disc to be opened by rotation of the spigot 152.

The valve closure members are seated on annular valve seats (not shown) defined inside the valve housings 158, 160. The valve seats are resiliently deformable and are generally located in respective recesses for receipt of the seat which, in use, is adapted to engage against a solid portion of the valve housings 158, 160.

The valve closure members are adapted to be pivotable through 90° or beyond, thus when in its fully open position the profile of the face of the valve closure members corresponds with the profile of the through bore of the valve housings 158, 160, and thereby provides minimal restrictions for the flow of fluid or other material.

FIG. 4 also shows that the two valve portions 154, 156 of the split valve assembly 150 are able to be locked and unlocked via rotation of a handle 166. This can only occur when the split valve assembly 150 is in a closed configuration.

Whilst the foregoing describes how the present invention can be embodied in a valve-actuating handle 140 for manual operation of a valve or coupling, and particularly a split butterfly valve assembly 150, the skilled person will appreciate that the invention can be implemented in any manner of transfer valve or coupling, such as, for example, split sliding gate valves, split ball valves, twin valves, rapid transfer ports and alpha beta ports.

Various modifications may be made to the present invention without departing from the scope of the invention. For example, although particular embodiments refer to implementing the present invention as a remote monitoring device on a valve or coupling, this is in no way intended to be limiting as, in use, the present invention could be implemented in any machine, process, equipment, product or asset where sensed information is desired. The invention is not restricted to the details of the foregoing embodiments.

1. A system for remotely monitoring a process or equipment, comprising:
processing means for receiving one or more sensed outputs representative of one or more environmental conditions and/or process parameters and/or equipment conditions;
interface means configurable by a user for selecting a subset of the one or more sensed outputs and for defining at least one output data string dependent on the one or more sensed outputs; and
communication means for transmitting the at least one output data string.

2. The system as claimed in claim 1, wherein the process is a process used in the manufacture of pharmaceutical products and/or the equipment is pharmaceutical process equipment.

3. The system as claimed in claim 2, wherein the pharmaceutical process equipment comprises at least one valve or coupling.

4. The system as claimed in claim 2, wherein the pharmaceutical process equipment comprises extraction and/or filtration system.

5. The system as claimed in any of claim 2, wherein the pharmaceutical process equipment comprises a glove box containment apparatus.

6. The system as claimed in claim 3, wherein the at least one valve or coupling is a powder transfer valve or coupling.

7. The system as claimed in claim 6, wherein the valve or coupling is selected from the group consisting of split butterfly valve, split sliding gate valve, split ball valve, twin valve, rapid transfer port and alpha beta port.

8. The system as claimed in claim 1, wherein the processing means is positioned on an actuator.

9. The system as claimed in claim 8, wherein the actuator comprises a manually-operable handle having an elongate shaft; one end of the shaft being rounded or dimensioned to form a knob; the other end of the shaft being dimensioned to form a central hub.

10. The system as claimed in claim 9, wherein the central hub comprises a first face for connection to the valve or coupling and an opposite second face that is visible to the operator.

11. The system as claimed in claim 10, wherein the first face of the central hub comprises a socket dimensioned to connect with a square spigot on the valve or coupling.

12. The system as claimed in any of claim 9, wherein the central hub defines a generally circular body into which a printed circuit board, battery and liquid crystal display is contained.

13. The system as claimed in any of claim 9, wherein the central hub defines a sealed, ingress protected enclosure.

14. The system as claimed in claim 1, wherein the processing means and communication means are located on the printed circuit board.

15. The system as claimed in claim 1, wherein the processing means is implemented in a low power microcontroller.

16. The system as claimed in claim 1, wherein the processing means receives a wake-up signal from user input buttons and/or from the one or more sensed outputs representative of one or more environmental conditions and/or process parameters and/or equipment conditions embedded on, or remote to, the printed circuit board.

17. The system as claimed in claim 1, further comprising display means for displaying at least one output signal to an operator via audio-visual, alphanumeric and/or haptic information.

18. The system as claimed in claim 1, wherein the one or more sensed outputs representative of one or more environmental conditions and/or process parameters and/or equipment conditions is selected from the group consisting of ambient temperature, process temperature, flow rate, light intensity, humidity, atmospheric pressure, process or material pressure, force measurement, operation time, power usage.

19. The system as claimed in claim 16, wherein the one or more sensed outputs is selected from the group consisting of photodiode, photoresistor, photodetector, resistance temperature detector, thermocouple, thermistor, piezoelectric, potentiometer, strain gauge, air flow sensor, anemometer, microphone, proximity sensor, motion sensor, Hall effect sensor.

20. The system as claimed in claim 1, wherein the at least one output data string dependent on the one or more sensed outputs is an error, misuse, or fault condition.

21. The system as claimed in claims 20, wherein the error, misuse, or fault condition is transmitted back to a remote server using a wired or wireless communications means.

22. The system as claimed in claim 1, wherein the processing means includes a GPS location module which records the location of the process or equipment.

23. The system as claimed in claim 1, wherein the processing means includes a unique identifier.

24. A system to monitor a process or equipment, comprising:
a central server;
a remote sensing device including a microprocessor for receiving one or more sensed outputs representative of one or more environmental conditions and/or process parameters and/or equipment conditions;
interface means in communication with the central server and the remote sensing device, the interface means being configurable by a user for selecting a subset of the one or more sensed outputs and for defining at least one output data string dependent on the one or more sensed outputs; and
wherein the central server is operable to download the user configurable data and at least one output data string over a wireless network.

25. A method of remotely monitoring a sensing device connected to a network, the sensing device comprising a microprocessor for receiving one or more sensed outputs representative of one or more environmental conditions and/or process parameters and/or equipment conditions, the method comprising the steps of:
selecting a subset of the one or more sensed outputs;
defining at least one configurable output data string dependent on the one or more sensed outputs; and
downloading the at least one configurable output data string to the sensing device.

26. The method as claimed in claim 25, further comprising the steps of:
assigning a unique user identifier;
assigning a unique device identifier; and
associating the unique user identifier with the unique device identifier.

27. The method as claimed in claim 25, further comprising the step of:
providing location information for the sensing device.

28. The method as claimed in any of claim 25, further comprising the step of:
providing location information and/or a unique identifier for the process or equipment.

29. The method as claimed in any of claim 25, further comprising the step of:
setting visual and/or audible display options for the sensing device.

30. The method as claimed in claim 25, wherein the step of selecting a subset of the one or more sensed outputs further comprises disabling one or more sensed outputs representative of one or more environmental conditions and/or process parameters and/or equipment conditions.

31. The method as claimed in claim 25, wherein the step of defining at least one configurable output data string further comprises defining at least one error, misuse, fault and/or event condition based on the subset of sensed outputs.

32. The method as claimed in claim 25, further comprising the step of transmitting the at least one configurable output data string populated by the at least one error, misuse, fault and/or event condition over a network.

33. The method as claimed in claim 25, wherein the selecting and defining steps of the method are carried out using a graphical user interface and/or application software.

34. A computer program product for remotely monitoring a sensing device connected to a network, the sensing device comprising a microprocessor for receiving one or more sensed outputs representative of one or more environmental conditions and/or process parameters and/or equipment conditions, comprising:
computer program product means for selecting a subset of the one or more sensed outputs;
computer program product means for defining at least one configurable output data string dependent on the one or more sensed outputs; and
computer program product means for downloading the at least one configurable output data string to the sensing device.

35-37. (canceled)
